(19) United States
(12) Patent Application Publication
(10) Pub. No.: US 2008/0123237 A1
(43) Pub. Date: May 29, 2008

(54) Method and Circuit for Amplifying the Input Signals of an Electronic Overcurrent Release of Low-Voltage Circuit Breakers with a Selectable Amplification Factor

(76) Inventors: Andreas Krauss, Berlin (DE); Andreas Pancke, Berlin (DE); Wolfgang Rohl, Berlin (DE); Manfred Schiller, Berlin (DE)

Correspondence Address: HARNESS, DICKEY & PIERCE, P.L.C., P.O.BOX 8910, RESTON, VA, 20195, US

(21) Appl. No.: 11/791,857

(22) PCT Filed: Nov. 10, 2005
(86) PCT No.: PCT/EP05/55880

§ 371 Date: May 30, 2007

(30) Foreign Application Priority Data
Nov. 30, 2004 (DE) 10 2004 058 763.9

(51) Int. Cl. H02H 3/08

(52) U.S. Cl. 361/93.6

(57) ABSTRACT

A method and a circuit are disclosed for amplifying the input signals of an electronic overcurrent release of low-voltage circuit breakers with a selectable amplification factor. The electronic overcurrent release includes at least one integrating condenser on the input side, and at least one pre-amplifier and a microprocessor. According to at least one embodiment of the invention, a resistance is coupled to a switch in series, parallel to an integrating condenser, and the switch is switched by way of the microprocessor in a pulsewidth-modulated manner. In this way, the effectively active resistance value of the inserted resistances is inversely increased proportionally to the pulsewidth repetition rate, thus obtaining an extremely wide regulating range.

### PRIORITY STATEMENT

This application is the national phase under 35 U.S.C. § 371 of PCT International Application No. PCT/EP2005/055880 which has an International filing date of Nov. 10, 2005, which designated the United States of America and which claims priority on German Patent Application number 10 2004 058 763.9 filed Nov. 30, 2004, the entire contents of which are hereby incorporated herein by reference.

### FIELD

Embodiments of the invention generally relate to a method and/or a circuit for amplifying the input signals of an electronic overcurrent release of low-voltage circuit breakers with a selectable amplification factor. For example, an electronic overcurrent release may include at least one integrating capacitor on the input side and at least one pre-amplifier and a microprocessor.

### BACKGROUND

Electronic overcurrent releases are used to monitor the current in a single-phase or multiple-phase power supply for the occurrence of excess currents and short-circuit currents. Depending on the level of an inadmissibly high current measured via current transformers, the overcurrent release causes the low-voltage circuit breaker to trip immediately or after a delay. The input signals for the electronic release are taken from the current transformers.

Rogowski coils, for example, are used as the current transformers, which, although they have a transfer characteristic without attenuation, their output signals only have a low power, so that they need to be amplified before being passed to a trip circuit, which is normally implemented by a microprocessor with an A/D converter connected to its input. In the microprocessor, the measured current signal after A/D conversion is compared with a reference voltage, so that a value exists at the output of the electronic overcurrent release that is normalized, for example, with respect to the rated current of an installation to be protected.

The input signals of the electronic release are amplified by an operational amplifier. The established practice is to set the amplification factor of this pre-amplifier by means of feedback resistors switched by analog switches, as shown in DE 198 25 384 A1 or DE 199 59 787 A1, for example.

A solution is also known in which a plurality of amplifiers made up of operational amplifiers are connected in parallel on the input side. The operational amplifiers have different amplification factors and, depending on the level of the input signal, are selected as signal sources by the microprocessor by means of the switches connected to the output of the amplifiers. The disadvantage with this solution is the high cost of the design using multiple components.

### SUMMARY

At least one embodiment of the invention defines a facility by which the amplification of a pre-amplifier in electronic overcurrent releases is set quickly, simply and at low cost.

In at least one embodiment, a resistor together with a series-connected switch is connected in parallel with an integrating capacitor, and the switch is switched in pulse-width modulation mode by way of the microprocessor. The effective resistance value of the inserted resistors can thereby be increased in inverse proportion to the pulse duty factor, and hence an extremely wide regulation range can be achieved. Since the connection is made directly to the integrating capacitors, the effect of interference on the analog signal can be kept vanishingly small.

A further advantage of at least one embodiment of this circuit is the reduced EMC sensitivity compared with the previous switchover arrangement of the feedback resistors of the operational amplifiers. In addition, just one resistor is required for different amplification factors. In the event that resistance tolerances of the resistors in the individual phases cause problems, a common resistor can also be used for all three/four amplification paths of the phases that are present.

### BRIEF DESCRIPTION OF THE DRAWINGS

The invention shall be explained in greater detail below with reference to example embodiments. In the attached drawings,

FIG. 1 shows a circuit according to an embodiment of the invention including three amplifiers, with one amplifier being provided for each current phase, and

FIG. 2 shows a version of the circuit of FIG. 1 having a common resistor for all current phases.

### DETAILED DESCRIPTION OF THE EXAMPLE EMBODIMENTS

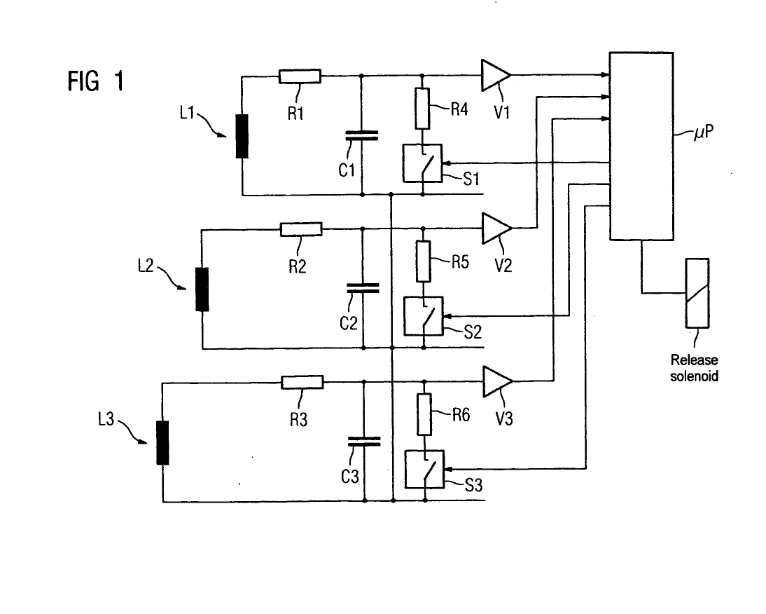

FIG. 1 shows a circuit according to an embodiment of the invention for an overcurrent release of a three-phase circuit breaker. Current sensors in the form of Rogowski coils L1 . . . L3 are used to detect the current in a power supply monitored by the circuit breaker. The signal from each Rogowski coil L1 . . . L3 is taken respectively to a pre-amplifier V1 . . . V3 via a resistor R1 . . . R3 and via an integrating capacitor C1 . . . C3 arranged in parallel. The outputs of the pre-amplifiers V1 . . . V3 are connected to a microprocessor μp. The microprocessor μp evaluates in clock cycles the current signal in the three phases, and decides in the event of an excess current upon switching off the circuit breaker by a signal to a release solenoid.

In order to set the amplification of the pre-amplifiers V1 . . . V3, resistors R4 . . . R6 are provided, which are arranged together with switches S1 . . . S3 in parallel with the integrating capacitors C1 . . . C3.

The switches S1 . . . S3 are switched in pulse-width modulation mode by the microprocessor μp. By changing the pulse duty factor, the resistance value of the resistors R4 . . . R6 can be varied in inverse proportion to the pulse duty factor, and hence the level of the input signal to the pre-amplifiers V1 . . . V3 can be varied.

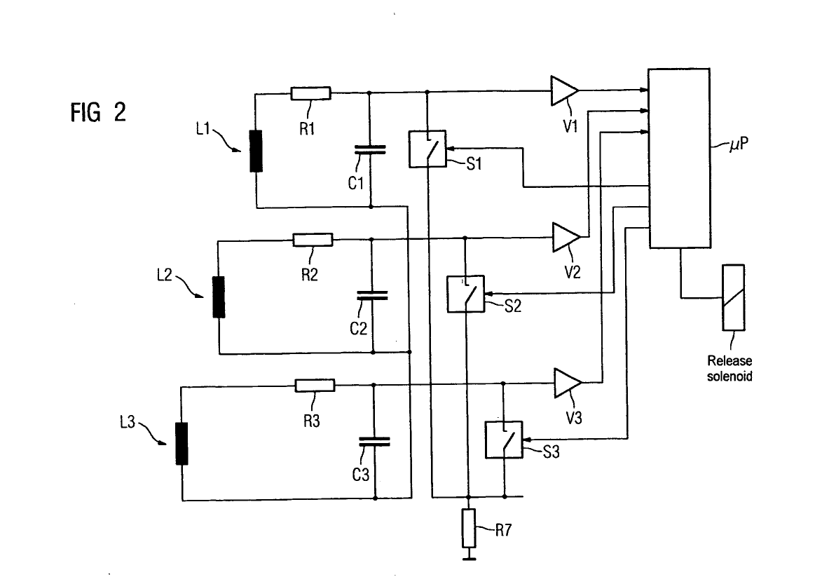

FIG. 2 shows a version of the circuit. Since only one of the preamplifiers V1 . . . V3 at a time ever has an effect on the microprocessor μp, and hence also only one of the switches S1 . . . S3 ever needs to be switched at one time, whilst the other two switches can be in the OFF position, it is possible to provide a common resistor R7 for all phases. In this version, the switches S1 . . . S3 are each connected on one side to the common resistor R7, and this resistor is then connected to ground.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCES

L1 . . . L3 Rogowski coils
R1 . . . R3 resistor
C1 . . . C3 integrating capacitor
V1 . . . V3 pre-amplifier
μp microprocessor
R4 . . . R6 resistor
S1 . . . S3 switch
R7 resistor

1. A method for amplifying input signals of an electronic overcurrent release of a low-voltage circuit breaker with a selectable amplification factor, the electronic overcurrent release including at least one integrating capacitor on an input side, at least one pre-amplifier and a microprocessor, the method comprising:
connecting a resistor, together with a series-connected switch, in parallel with an integrating capacitor; and
switching the switch in pulse-width modulation mode via the microprocessor.

2. A circuit for amplifying the input signals of an electronic overcurrent release of a low-voltage circuit breaker with a selectable amplification factor, the electronic overcurrent release including at least one integrating capacitor on an input side, at least one pre-amplifier and a microprocessor, the circuit comprising:
a resistor; and
a switch, connected in series with the resistor and switchable in pulse-width modulation mode via the microprocessor, connected in parallel with an integrating capacitor.

3. The circuit as claimed in claim 2, wherein the switches are each connected by one pole to ground via a common resistor.

4. The method as claimed in claim 1, wherein the switch is connected by one pole to ground via a resistor.

5. The circuit as claimed in claim 2, wherein the switch is connected by one pole to ground via a resistor.
